(19) United States
(12) Patent Application Publication
(10) Pub. No.: US 2019/0271996 A1
(43) Pub. Date: Sep. 5, 2019

(54) THERMOSTAT ASSEMBLY WITH PRESSURE COMPENSATION

(71) Applicant: M.A.P. MOTORAD AUTOMOTIVE PARTS LTD, Misgav (IL)

(72) Inventor: Aviram ARBEL, Hod Hasharon (IL)

(21) Appl. No.: 16/348,251

(22) PCT Filed: Nov. 1, 2017
(86) PCT No.: PCT/IL2017/051190

§ 371 Date: May 8, 2019

Related U.S. Application Data
(60) Provisional application No. 62/421,299, filed on Nov. 13, 2016.

(51) Int. Cl. G05D 23/13; F01P 7/16; G05D 23/19

(52) U.S. Cl. CPC G05D 23/1333; F01P 2007/146; G05D 23/1921; F01P 7/167

(57) ABSTRACT

There is provided herein a thermostat for controlling flow of a coolant fluid through an aperture, the thermostat comprising a temperature sensitive valve for controlling the opening and closing of the aperture, said temperature sensitive valve comprising: a valve body comprising a heat sensitive material and a displaceable pin; wherein said displaceable pin is at least partially inserted within said heat sensitive material; a lid configured to delimit the temperature sensitive valve from a top end thereof, said lid configured to seal against a valve seat when said temperature sensitive valve is closed; a support member configured to delimit the temperature sensitive valve from a bottom end thereof; and a flexible member located between said lid and said support member, wherein when said heat sensitive material is heated said displaceable pin is at least partially displaced from said valve body, thereby affecting a compression force on said flexible member, said compression force gradually displacing said temperature sensitive valve from said valve seat, thereby allowing flow of coolant fluid through said aperture, and a hydraulic pressure compensation mechanism mechanically connected to, or associated with, said lid and configured to at least partially compensate for a hydraulic pressure exerted by said coolant fluid on said lid of said temperature sensitive valve by providing a means for redirecting hydraulic pressure away from said lid of said temperature sensitive valve.

### FIELD

The present disclosure generally relates to the field of thermostats and temperature controlled fluid flow.

### BACKGROUND

Thermostats are extensively used to control the circulation of coolant in internal combustion engines. Typically, thermostats include valves having a closed body containing a thermally expandable material, such as wax. A spring is provided to urge the valve to a closed position such that in the resting or cooled state the valve is normally closed. Hence, when the engine is first started, the valve is closed, allowing only a bypass circulation of coolant fluid between the engine and the thermostat, thereby enabling the engine to attain its optimum running temperature more quickly.

Once the engine temperature rises, the temperature of the bypass circulated fluid increases, causing the wax within the valve body to melt and expand, consequently thrusting out a rod. As a result, the out-thrust rod causes displacement of the valve from the valve seat, allowing flow of coolant fluid from a heat exchanger, such as a radiator, to the engine. As the engine temperature drops, the wax temperature falls, the valve closes, and the thermostat returns to bypass circulation only.

There is still an unmet need for a device which is capable of fine-tuning the opening and closing of the valve on demand, to enable lower and/or higher Start-to-Open (STO) temperature.

### SUMMARY

The following embodiments and aspects thereof are described and illustrated in conjunction with systems, kits and devices which are meant to be exemplary and illustrative, not limiting in scope. In various embodiments, one or more of the above-described problems have been reduced or eliminated, while other embodiments are directed to other advantages or improvements.

The present disclosure relates to thermostat assemblies having a hydraulic pressure compensation mechanism configured to compensate for the hydraulic pressure exerted by coolant fluid on the valve's lid.

State of the art thermostats typically require the engine designer to determine an optimum engine temperature by deciding on properties of the wax, properties of a spring urging the valve to be closed, and/or additional parameters influencing the pre-determined STO temperature of the valve. An engine's efficiency tends to improve with its operating temperature along with its fuel economy. However, many engine components begin to break down as engine temperature increases. Thus, a compromise must be made and a single optimum engine temperature selected. However, given the optimum engine temperature and the corresponding set of design parameters, there may result constraints being placed on thermostat characteristics. For example, selection of a spring with a particular spring constant may place a constraint on the size of the valve and thus the overall size of the thermostat (that is, it may limit how small it can be made). For example, selection of a preload force placed on the spring may be affected by the size of the valve and the spring constant. For example, selection of a particular set of the abovementioned parameters may constrain or define the pre-determined STO temperature and/or the size of the thermostat.

Advantageously, the thermostat disclosed herein, according to some embodiments, includes a hydraulic pressure compensation mechanism configured to compensate for the hydraulic pressure exerted by coolant fluid on the valve lid. Due to the pressure compensation, the spring needed to urge the valve to a closed position might have a lower spring constant than that typically used in thermostats, such as thermostats typically used in combustion engines. Because a spring with a lower spring constant may be used, the thermostat disclosed herein may, according to some embodiments, be smaller or retain a similar size to standard thermostat assemblies, without requiring additional adjustments or modification of the engine. Moreover, according to some embodiments, the lower spring constant may allow a smaller thermo stat.

According to some embodiments, a hydraulic pressure compensation mechanism disclosed herein may comprise an elastic diaphragm as part of a mechanical assembly within a thermostat. Advantageously, the thermostat disclosed herein may enable adjustment of the STO temperature via appropriate selection of the properties of the elastic diaphragm (e.g.; dimensions, elasticity, and/or resilience) in addition to, or instead of, allowing use of a spring with a lower spring constant.

According to some embodiments, there is provided herein a thermostat for controlling flow of a coolant fluid through an aperture, the thermostat comprising: a temperature sensitive valve for controlling the opening and closing of the aperture, the temperature sensitive valve comprising: a valve body comprising a heat sensitive material and a displaceable pin; wherein the displaceable pin is at least partially inserted within the heat sensitive material; a lid configured to delimit the temperature sensitive valve from a top end thereof, the lid configured to seal against a valve seat when the temperature sensitive valve is closed; a support member configured to delimit the temperature sensitive valve from a bottom end thereof; and a flexible member located between the lid and the support member, wherein when the heat sensitive material is heated the displaceable pin is at least partially displaced from the valve body, thereby affecting a compression force on the flexible member, the compression force gradually displacing the temperature sensitive valve from the valve seat, thereby allowing flow of coolant fluid through the aperture; and a hydraulic pressure compensation mechanism mechanically connected to, or associated with, the lid and configured to at least partially compensate for a hydraulic pressure exerted by the coolant fluid on the lid of the temperature sensitive valve by providing a means for redirecting hydraulic pressure away from the lid of the temperature sensitive valve.

According to some embodiments, the hydraulic pressure element comprises: an extension element mechanically connected to, or associated with, the lid, an annular structure mechanically connected to, or associated with, the extension element, an elastic membrane configured to slideably engage the annular structure to a thermostat wall, configured such that, together, the extension element, the annular structure, the elastic membrane and thermostat wall form a fluid chamber above the lid.

According to some embodiments, when the fluid chamber fills with coolant fluid, the membrane is configured to slide against the thermostat wall, increase a volume of the fluid chamber, and thereby relieve some of the pressure directed against the lid, thus at least partially compensating for fluid pressure acting on the lid.

According to some embodiments, the flexible member is a spring. According to some embodiments, the spring has a spring constant of about 5000 Newton/meter or less. According to some embodiments, the spring has a spring constant of about 4000 Newton/meter or less. According to some embodiments, the spring has a spring constant of about 2500 Newton/meter or less.

According to some embodiments, the heat sensitive material is a wax. According to some embodiments, the temperature sensitive valve is a fast-opening valve. According to some embodiments, the temperature sensitive valve is a linear characteristic valve. According to some embodiments, the temperature sensitive valve is a logarithmic valve.

According to some embodiments, there is provided herein a thermostat system for controlling a temperature of an engine, the system comprising: a thermostat for controlling flow of a coolant fluid through an aperture, the thermostat comprising: a temperature sensitive valve for controlling the opening and closing of the aperture, the temperature sensitive valve comprising: a valve body comprising a heat sensitive material and a displaceable pin; wherein the displaceable pin is at least partially inserted within the heat sensitive material; a lid configured to delimit the temperature sensitive valve from a top end thereof, the lid configured to seal against a valve seat when the temperature sensitive valve is closed; a support member configured to delimit the temperature sensitive valve from a bottom end thereof; and a flexible member located between the lid and the support member, wherein when the heat sensitive material is heated, the displaceable pin is at least partially displaced from the valve body, thereby affecting a compression force on the flexible member, the compression force gradually displacing the temperature sensitive valve from the valve seat, thereby allowing flow of coolant fluid through the aperture; and a hydraulic pressure compensation mechanism mechanically connected to, or associated with, the lid and configured to at least partially compensate for a hydraulic pressure exerted by the coolant fluid on the lid of the temperature sensitive valve by providing a means for redirecting hydraulic pressure away from the lid of the temperature sensitive valve.

According to some embodiments, the thermostat system further includes a bypass circuitry configured to circulate the coolant fluid between the engine and the thermostat.

According to some embodiments, the thermostat system further includes a pump configured to pump coolant fluid from the thermostat to the engine.

Certain embodiments of the present disclosure may include some, all, or none of the above advantages. One or more technical advantages may be readily apparent to those skilled in the art from the figures, descriptions and claims included herein.

Moreover, while specific advantages have been enumerated above, various embodiments may include all, some, or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1A schematically shows a top view and a rear cross-sectional view, taken along line E-E of the top view, of an apparatus with a hydraulic pressure compensation mechanism configured to control the flow of a coolant fluid from a radiator to an engine, in a closed position, according to some embodiments;

FIG. 1B schematically shows a front cross-sectional view, taken along line E-E of the top view of apparatus of FIG. 1A, in a 3D perspective, according to some embodiments;

FIG. 2A schematically shows a front cross-sectional view, taken along line E-E of the top view of FIG. 1A, of an apparatus with a hydraulic pressure compensation mechanism configured to control the flow of a coolant fluid from a radiator to an engine, in an open position, according to some embodiments; and

FIG. 2B schematically shows a rear cross-sectional view, taken along line E-E of the top view of an apparatus of FIG. 1A, in a 3D perspective, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, the present disclosure provides a thermostat for controlling a temperature of an engine by controlling flow from a heat exchanger, such as a radiator, to the engine. As used herein, the terms “heat exchanger” and “radiator” may be used interchangeably to refer to an external device such as a radiator that either reduces the temperature of (cools) fluid passing through the device or exchanges fluid at one temperature for fluid at a lower temperature. The thermostat includes a temperature sensitive valve for controlling the opening and closing of an aperture, through which the coolant fluid cooled by the radiator can enter the thermostat and subsequently the engine.

According to some embodiments, the present disclosure provides a thermostat for controlling a temperature of an engine by controlling flow of a fluid from a heat exchanger such as a radiator, to the engine. As used herein, the terms “coolant” and “low temperature fluid” may be used interchangeably to refer to a fluid provided by a heat exchanger for use by an engine, supplied at a lower temperature than a fluid circulating within the engine.

According to some embodiments, the temperature sensitive valve includes a displaceable and/or thermally actuated mechanism configured to allow opening of the temperature sensitive valve, in response to an increase in the temperature of the coolant fluid circulating in the engine. The temperature sensitive valve further includes a flexible member, configured to exert pressure on the temperature responsive valve so as to resist opening of the valve and/or to force closing of the valve, when the temperature of the coolant fluid decreases. According to some embodiments, the flexible member may be a spring.

According to some embodiments, the temperature sensitive valve includes a valve body comprising a heat sensitive material and a displaceable pin. According to some embodiments, the displaceable pin may be at least partially inserted within the valve body and/or the heat sensitive material. According to some embodiments, the heat sensitive material may be a wax. As used herein, the terms “heat sensitive material,” “thermally expandable material,” and “wax” may be used interchangeably to refer to a material that expands when heated and contracts when cooled at temperatures advantageous for engine operation. According to some embodiments, the heat sensitive material may be configured to melt and expand at a temperature in the range of 90° C.-95° C., in the range of 91° C.-94° C., or in the range of 91° C.-93° C. Each possibility presents a separate embodiment.

According to some embodiments, the valve may include a lid configured to delimit the temperature sensitive valve from a top end thereof. According to some embodiments, the lid may include a flange configured to close off the aperture through which coolant fluid enters the thermostat from a heat exchanger such as a radiator. According to some embodiments, the lid may have the form of a disc. According to some embodiments, the lid may be essentially flat. According to some embodiments, the lid may be essentially dome formed. According to some embodiments, at least part of the lid may have concave shape. According to some embodiments, the lid may have a size and shape configured to improve the flow characteristics of the coolant fluid through the aperture. According to some embodiments, the lid may be sized and shaped to ensure a gradual increase of flow of the coolant fluid through the opening of the valve, as the valve is opened. According to some embodiments, the lid may be sized and shaped to prevent a burst in the flow of coolant fluid through the aperture.

According to some embodiments, the thermostat may include a valve seat. As used herein, the term “valve seat” may refer to part of the thermostat against which the temperature sensitive valve seals. As used herein, the terms “aperture” and “opening” may be interchangeably used and may refer to the gap created when the lid unseals from the valve seat and may be the narrowest point through which the fluid passes into the thermostat. According to some embodiments, the valve seat may be functionally connected to the temperature sensitive valve.

According to some embodiments, the temperature sensitive valve may include a support member configured to delimit the temperature sensitive valve from a bottom end thereof. According to some embodiments, the support member may be a lower bridge. According to some embodiments, the support member may be fixed within the thermostat, thereby providing contra force to a downward movement of the lid and flexible member.

According to some embodiments, when the heat sensitive material is heated, the displaceable pin may be at least partially thrust out from the valve body. According to some embodiments, when the displaceable pin is thrust out from the valve body it may encounter a niche formed within the thermostat and configured to provide contra force to the displacement of the displaceable pin, thereby affecting a compression force on the flexible member. According to some embodiments, the compression force exerted on the flexible member may gradually displace the temperature sensitive valve from the aperture, thereby allowing flow of coolant fluid from a radiator through the aperture, into the engine.

According to some embodiments, when the valve seals off the aperture, the coolant fluid flows in a bypass circuitry between the engine and the thermostat.

According to some embodiments, when the valve is displaced from the seal, the coolant fluid flows through a heat exchanger, such as a radiator, where it gets cooled prior to being circulated back to the engine.

According to some embodiments, the thermostat advantageously includes a hydraulic pressure compensation mechanism. As used herein, the term “hydraulic pressure compensation mechanism” may refer to any element configured to compensate for the hydraulic pressure exerted by coolant fluid on the lid of the temperature sensitive valve.

According to some embodiments, the hydraulic pressure compensation mechanism may comprise an O-ring structure with an outer diameter slightly less than the diameter of the inner wall of the thermostat and may be mechanically connected to, or associated with, the lid by an extension element, and located above the lid. According to some embodiments, the O-ring structure may be engaged with the inner wall of the thermostat via an elastic diaphragm, attached to the O-ring structure and the inner wall. According to some embodiments, the O-ring structure and elastic membrane, the inner wall of the thermostat and the lid together form a fluid chamber above the lid into which may flow fluid from a radiator.

As the chamber fills with fluid, fluid pressure is created. Pressure applied to the valve's lid by the fluid work against the pressure applied by the tension of the flexible member, making it easier to open the valve. However, pressure applied to the hydraulic pressure compensation mechanism works against the pressure being applied to the valve's lid. Some of the pressure applied against the hydraulic pressure compensation mechanism may cause the elastic membrane to flex upward, away from the valve. Some of the pressure applied against the hydraulic pressure compensation mechanism may additionally push the O-ring structure in the opposite direction as the pressure acting directly on the valve's lid. Because the O-ring structure is mechanically connected to, or associated with, the lid, fluid pressure thus acting against it works against the pressure acting in the opposite direction against the valve's lid. Due to either or both these factors, the hydraulic pressure compensation mechanism at least partially compensates for fluid pressure exerted by fluid in the chamber on the valve's lid.

According to some embodiments, the degree of compensation provided by the hydraulic pressure compensation mechanism is essentially unchanged between the open and closed configurations of the thermostat. Due to the pressure compensation provided by the hydraulic pressure compensation mechanism, the strength of the flexible member needed to urge the valve to a closed position may be lower. The spring, according to embodiments, may have a spring constant of about 500-1500 N/m or below, about 700-1000 N/m or below, about 800-900 N/m or below, or about 890 N/m or below. Each possibility is a separate embodiment.

According to some embodiments, due to the pressure compensation provided by the hydraulic pressure compensation mechanism and its effect on the selection of the spring constant for the flexible member (spring), the force of the preload applied to the spring may be affected. In some embodiments, the preload may be reduced. For example, the initial preload may be about 5-15 N, about 7-12 N, about 6-11 N, or about 10 N.

In some embodiments, the preload may be increased.

The term “Start to Open (STO) temperature”, as used herein, refers to a temperature range, at which the thermostat valve is configured to open and to allow coolant fluid flow from the radiator to the engine. As used herein, the term “predetermined STO temperature” may refer to the default STO temperature set by the manufacturer.

According to some embodiments, the thermostat disclosed herein may be configured to facilitate elevating the STO temperature above the predetermined STO temperature of the valve, thereby increasing the engine temperature and fuel utilization. According to some embodiments, the thermostat disclosed herein may be configured to facilitate lowering the STO temperature below the predetermined STO temperature of the valve, thereby reducing wear and tear on engine components.

According to some embodiments, the temperature sensitive valve may have a predetermined inherent flow characteristic, which defines the relationship between the valve opening and the flow-rate under constant pressure conditions. It is understood that the relationship between flow-rate and aperture pass area is directly proportional.

However, different valve characteristics may give different valve openings for the same pass area. The physical shape of the valve and seat arrangement, sometimes referred to as the valve ‘trim’, causes a difference in valve opening between valves. According to some embodiments, the valve may be sized and shaped to improve the flow characteristics of the coolant fluid through the aperture.

According to some embodiments, the valve may be a fast opening valve. As used herein, the term “fast opening valve” may refer to a valve in which a small lift of the valve from the closed position results in a large change in flow-rate. As a non-limiting example, a valve lift of 50% may result in an orifice pass area and flow-rate of up to 90% of its maximum potential. According to some embodiments, the lid of the fast opening valve may have a shape of a flipped flat bowl. According to some embodiments, the lid of the fast opening valve may at least partially have a convex shape.

According to some embodiments, the valve may be a linear characteristic valve. As used herein, the term “linear characteristic valve” refers to a valve having a flow-rate directly proportional to the valve lift, at a constant differential pressure. A linear valve achieves this by having a linear relationship between the valve lift and the orifice pass area. According to some embodiments, the lid of the linear characteristic valve may have a shape of a dome. According to some embodiments, the lid of the linear characteristic valve may at least partially have a concave shape.

According to some embodiments, the valve may be a logarithmic valve. As used herein, the term “logarithmic valve,” also sometimes known as an “equal percentage” valve, refers to one in which each increment in valve lift increases the flow-rate by a certain percentage of the previous flow. According to some embodiments, the lid of the logarithmic valve may at least partially have a concave shape and, partially, a convex shape.

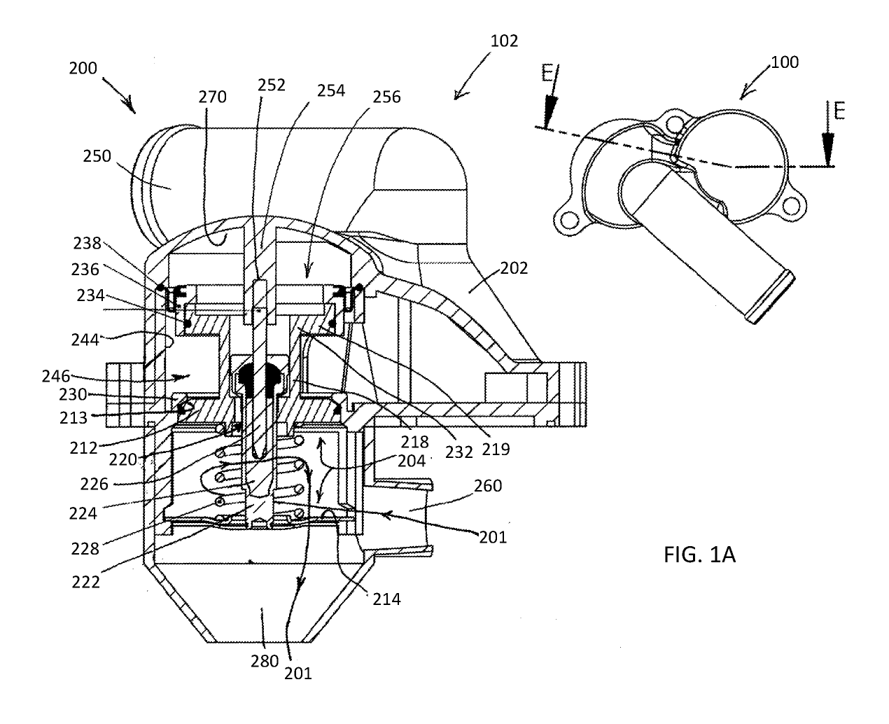

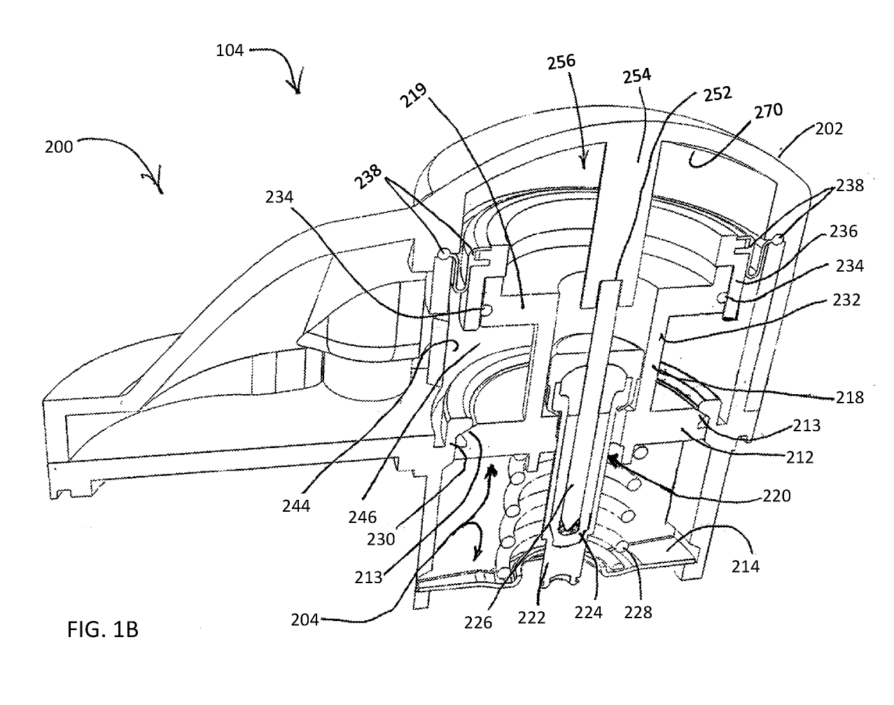

Reference is now made to FIGS. 1A & 1B. FIG. 1A schematically shows a top view 100 and a rear cross-sectional view 102, taken along line E-E of the top view 100, of a thermostat 200 in a closed mode, according to some embodiments. FIG. 1B shows a front cross-sectional view 104, taken along line E-E of the top view of apparatus of FIG. 1A, in a 3D perspective, in a closed mode, according to some embodiments.

Thermostat 200 includes a main body 202 housing a valve 204, configured to block or allow flow of coolant fluid from radiator passage 250 to engine passage 280 therethrough. Valve 204 is here depicted as a linear characteristic valve configured to optimize the flow of coolant fluid when opened; however, fast opening valves, logarithmic valves or any other type of valve may likewise be utilized and fall within the scope of this disclosure. Valve 204 includes a temperature sensitive actuator 220, a lid 212, a support member 214 and a spring 228, positioned between lid 212 and support member 214.

Temperature sensitive actuator 220 includes an actuator body 222 containing heat sensitive material 224 configured to expand above a predetermined temperature, and displaceable pin 226 partially disposed within heat sensitive material 224 and partially projecting into niche 252 formed in bridge element 254 of main body 202 of thermostat 200. Bridge element 254 is substantially cylindrical and is integrally formed on, or mechanically fixedly connected to, domed roof 270 of main body 202 of thermostat 200.

Extension 232 is integrally formed on or, alternatively, mechanically connected to, lid 212. A flange 213 is formed on outer upper rim of lid 212 of valve 204. Extension 232 perpendicularly extends from a central part of lid 212 and has a lower hollow cylindrical portion 218 and an upper annular portion 219 extending outward from hollow cylindrical portion. Upper annular portion 219 is shaped substantially like a flat doughnut with an outer lip extending upward.

Temperature sensitive actuator 220 is disposed within hollow cylindrical portion 218 and upper annular portion 219 of extension 232 of valve 204. Spring 228 is configured to force closing of valve 204, as long as a predetermined STO temperature (T1) has not been reached, as depicted in FIGS. 1A & 1B. Flange 213 is configured to create a valve seal between lid 212 and valve seat 230 when valve 204 is closed by spring 228 urging lid 212 upward, thus blocking the flow of fluid through valve 204, from radiator passage 250 to engine passage 280.

Thermostat 200 further includes a hydraulic pressure compensation mechanism 256, which includes annular connector 236, O-ring 234, and elastic membrane 238 and makes use of upper annular portion 219 of extension 232 of lid 212. Annular connector 236 is located circumferentially to and mechanically connected to upper annular portion 219 of extension 232 and sealed by O-ring 234. Annular connector 236 is further engagedly associated with inner wall 244 of the thermostat by elastic membrane 238. Elastic membrane 238 is substantially annular, with inner and outer lip appendages configured for engaging both connector 236 and inner wall 244 of the thermostat.

Together, annular connector 236, elastic membrane 238, temperature sensitive actuator 220 and inner wall 244 of the thermostat form a fluid chamber 246 above lid 212 into which may flow coolant fluid from a radiator.

In its closed operation mode (as depicted in FIGS. 1A & 1B), lid 212 of valve 204 seals against valve seat 230, thereby preventing flow of coolant fluid from radiator passage 250 to engine passage 280, through valve 204.

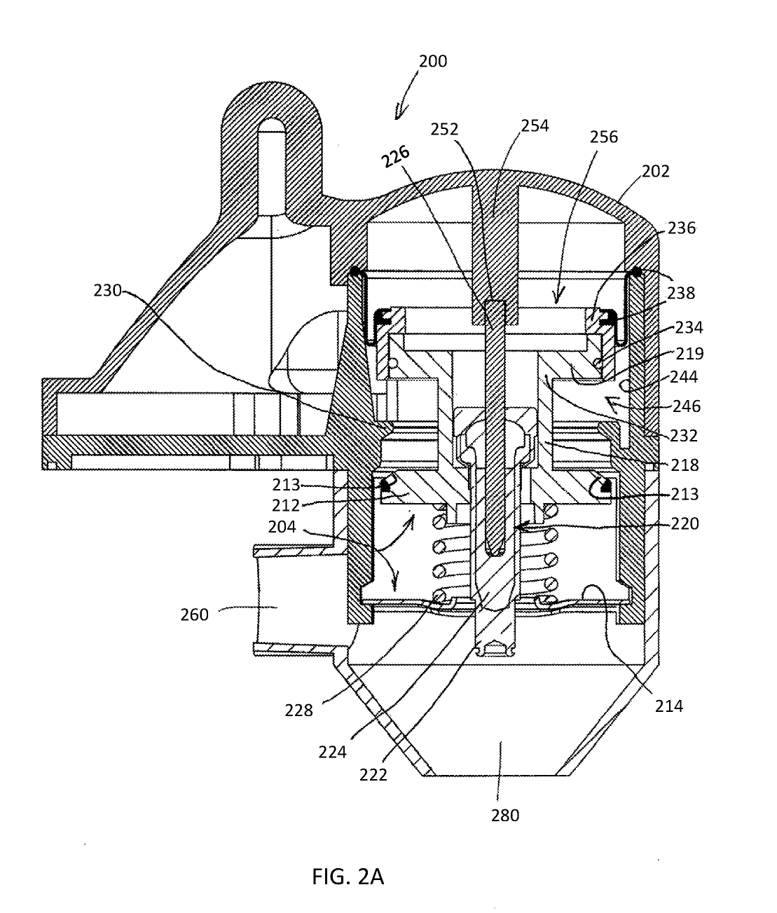

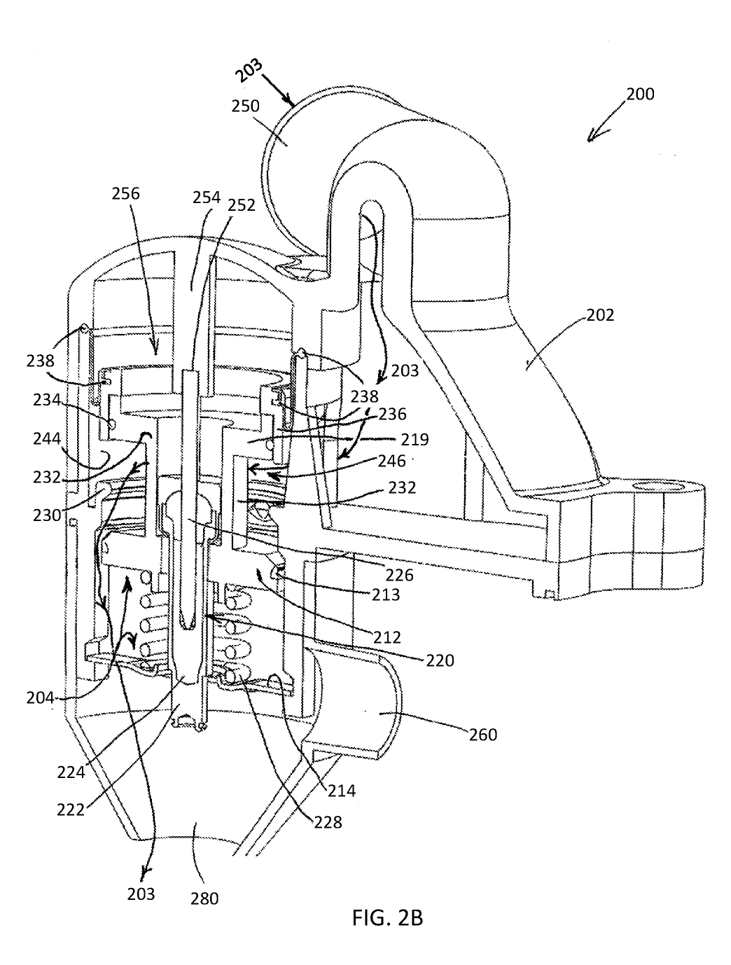

Reference is now made to FIGS. 2A & 2B. FIG. 2A schematically shows a front cross-sectional view, taken along line E-E of the top view 100 (of FIG. 1A), of a thermostat 200 in an open mode, according to some embodiments. FIG. 2B shows a front cross-sectional view, taken along line E-E of the top view 100 of an apparatus of FIG. 1A, in a 3D perspective, in an open mode, according to some embodiments.

As in FIGS. 1A & 1B, thermostat 200 comprises valve 204 configured to block or allow flow of coolant fluid from radiator passage 250 to engine passage 280 through valve 204. Valve 204 includes a temperature sensitive actuator 220, a lid 212, a support member 214 and a spring 228, positioned between lid 212 and support member 214.

Temperature sensitive actuator 220 comprises valve body 222 containing heat sensitive material 224. When the coolant fluid gets heated to or above the predetermined STO temperature (T1), heat sensitive material 224 expands thereby causing displaceable pin 226 to be partially thrust out of valve body 222. Due to the contra force provided by niche 252 to the displacement of pin 226, spring 228 is compressed, leading lid 212 to be gradually displaced from valve seat 230, thereby generating a pass for coolant fluid cooled by radiator, from radiator passage 250 through valve 204 and, by means of pump (not shown), to engine passage 280, as denoted by arrow 203. That is, when valve 204 is in its open operation mode (as shown in FIGS. 2A & 2B), spring 228 is compressed, forcing lid 212 of valve 204 to detach from valve seat 230, thereby allowing flow of coolant fluid from radiator passage 250 to the engine, via engine passage 280.

In operation, hydraulic pressure compensation mechanism 256 functions as described herein. When fluid chamber 246 is filled with fluid, hydraulic pressure creates a downward force against lid 212 and upward force against upper annular portion 219 and annular connector 236, causing elastic membrane 238 to flex upward. This relieves at least some of the pressure directed downward against lid 212, thus at least partially compensating for the fluid pressure acting on lid 212.

It is understood that, due to the pressure compensation provided by hydraulic pressure compensation mechanism 256, the force needed to cause lid 212 to seal with valve seat 230 is reduced and thus the spring constant of spring 228 may be relatively low, such as 900 N/m or below. Additionally or alternatively, the STO (T₁) may be reduced, for example to T₂ where T₂<T₁.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

What is claimed is:

1. A thermostat for controlling flow of a coolant fluid through an aperture, the thermostat comprising:
a temperature sensitive valve for controlling the opening and closing of the aperture, said temperature sensitive valve comprising:
a valve body comprising a heat sensitive material and a displaceable pin; wherein said displaceable pin is at least partially inserted within said heat sensitive material;
a lid configured to delimit the temperature sensitive valve from a top end thereof, said lid configured to seal against a valve seat when said temperature sensitive valve is closed;
a support member configured to delimit the temperature sensitive valve from a bottom end thereof; and
a flexible member located between said lid and said support member;
wherein when said heat sensitive material is heated said displaceable pin is at least partially displaced from said valve body, thereby affecting a compression force on said flexible member, said compression force gradually displacing said temperature sensitive valve from said valve seat, thereby allowing flow of coolant fluid through said aperture; and
a hydraulic pressure compensation mechanism mechanically connected to, or associated with, said lid and configured to at least partially compensate for a hydraulic pressure exerted by said coolant fluid on said lid of said temperature sensitive valve by providing a means for redirecting hydraulic pressure away from said lid of said temperature sensitive valve.

2. The thermostat of claim 1, wherein said hydraulic pressure element comprises: an extension element mechanically connected to, or associated with, said lid, an annular structure mechanically connected to, or associated with, said extension element, an elastic membrane configured to slideably engage said annular structure to a thermostat wall, configured such that, together, said extension element, said annular structure, said elastic membrane and said thermostat wall form a fluid chamber above said lid.

3. The thermostat of claim 1, wherein, when said fluid chamber fills with coolant fluid, said membrane is configured to slide against said thermostat wall, increase a volume of said fluid chamber and thereby relieves some of the pressure directed against said lid, thus at least partially compensating for fluid pressure acting on said lid.

4. The thermostat of claim 1, wherein said flexible member is a spring.

5. The thermostat of claim 4, wherein said spring has a spring constant of about 5000 Newton/meter or less.

6. The thermostat of claim 4, wherein said spring has a spring constant of about 4000 Newton/meter or less.

7. The thermostat of claim 4, wherein said spring has a spring constant of about 2500 Newton/meter or less.

8. The thermostat of claim 1, wherein said heat sensitive material is a wax.

9. The thermostat of claim 1, wherein said temperature sensitive valve is a fast-opening valve.

10. The thermostat of claim 1, wherein said temperature sensitive valve is a linear characteristic valve.

11. The thermostat of claim 1, wherein said temperature sensitive valve is a logarithmic valve.

12. A thermostat system for controlling a temperature of an engine the system comprising:
a thermostat for controlling flow of a coolant fluid through an aperture, the thermostat comprising:
a temperature sensitive valve for controlling the opening and closing of the aperture, said temperature sensitive valve comprising:
a valve body comprising a heat sensitive material and a displaceable pin; wherein said displaceable pin is at least partially inserted within said heat sensitive material;
a lid configured to delimit the temperature sensitive valve from a top end thereof, said lid configured to seal against a valve seat when said temperature sensitive valve is closed;
a support member configured to delimit the temperature sensitive valve from a bottom end thereof; and
a flexible member located between said lid and said support member;
wherein when said heat sensitive material is heated, said displaceable pin is at least partially displaced from said valve body, thereby affecting a compression force on said flexible member, said compression force gradually displacing said temperature sensitive valve from said valve seat, thereby allowing flow of coolant fluid through said aperture; and
a hydraulic pressure compensation mechanism mechanically connected to, or associated with, said lid and configured to at least partially compensate for a hydraulic pressure exerted by said coolant fluid on said lid of said temperature sensitive valve by providing a means for redirecting hydraulic pressure away from said lid of said temperature sensitive valve.

13. The thermostat system of claim 12, further comprising a bypass circuitry configured to circulate said coolant fluid between said engine and said thermostat.

14. The thermostat system of claim 13, further comprising a pump configured to pump coolant fluid from said thermostat to said engine.
